(19) United States
(12) Patent Application Publication
(10) Pub. No.: US 2022/0169775 A1
(43) Pub. Date: Jun. 2, 2022

(54) URETHANE RESIN COMPOSITION AND BUILDING INSULATION METHOD

(71) Applicant: NIPPON AQUA CO., LTD., Tokyo (JP)

(72) Inventor: Kazuhisa NAGATA, Tokyo (JP)

(21) Appl. No.: 17/436,973

(22) PCT Filed: Jul. 12, 2019
(86) PCT No.: PCT/JP2019/027699

§ 371 Date: Sep. 7, 2021

(30) Foreign Application Priority Data
Aug. 30, 2018 (JP) 2018-161392

(51) Int. Cl. C08G 18/09; C08K 5/521; C08K 3/32; C08J 9/14; C08G 18/40; E04B 1/76

(52) U.S. Cl. CPC C08G 18/09; C08K 5/521; C08K 3/32; C08J 9/146; C08G 2150/60; E04B 1/76; C08K 2003/323; C08J 2203/10; C08J 2375/06; C08G 18/4018

(57) ABSTRACT

A urethane resin composition having properties suitable for forming a building insulation layer without adding a foam stabilizer in a urethane resin composition having at least quasi-incombustibility. A urethane resin composition for forming a foam that constitutes a insulation material for a building includes a foam having at least quasi-incombustibility in a heat-release test complying with ISO-5660, the urethane resin composition containing at least a polyisocyanate compound, an ester polyol compound, a trimerization catalyst, an additive, and a non-silicon surface adjuster, and by not containing a foam stabilizer, the additive including red phosphorus as an essential component and being combined with a phosphate-containing flame retardant and/or a chlorine-containing flame retardant.

### CROSS REFERENCE TO RELATED APPLICATIONS

This application claims the benefit of priority to International Patent Application No. PCT/JP2019/027699 filed on Jul. 12, 2019 claiming priority to Japanese Patent Application No. 2018-161392, filed on Aug. 30, 2018, of which full contents are incorporated herein by reference.

### BACKGROUND

### Technical Field

The present disclosure relates to a urethane resin composition or the like to be used for a thermal insulation material for a building, and more specifically to a urethane resin composition formable into a foam body exhibiting at least quasi-incombustibility in a heat generation test (calorific measurement) in conformity with the ISO-5660 standard.

### Description of the Related Art

In a house built of RC (reinforced concrete) and house built of S (steel) frame, a sprayed hard urethane foam as thermal insulation material has often been used for the purpose of dew-condensation prevention, thermal insulation and energy saving.

In recent years, there have been some cases of fire sometimes caused by the ignition of any thermal insulation materials due to any inappropriate construction management or the like. Even in the case of any general fire, there have been some other cases of fire caught by any thermal insulation materials causing the spread of fire.

In order to prevent a urethane foam from being burned, some fire-resistant coatings (inorganic spray materials such as cement-based materials) have been applied to the urethane foam. There have still been problems, however, that: it takes a long time to apply such coatings to the urethane foam; the coatings adhered insufficiently to the urethane foam after application fall off from the urethane foam; and the like.

As described in Patent Document 1 shown below, a urethane resin composition has been obtained by adding thereto a flame retardant containing red phosphorus as an indispensable component in order to impart flame-retardancy to the urethane foam.

### PRIOR ART DOCUMENTS

### Patent Documents

Patent Document 1: Japanese Patent No. 6200435

### Problems to be Solved

The urethane resin composition described in Patent Document 1 has faced at least one of the following problems:
(1) As a result of a self-adhesive force within urethane being weakened by a foam stabilizer as an indispensable component, a foam body of the urethane has been likely to fall off from the sprayed surface. In particular, for making a thermal insulation layer to be provided for a building, spraying repeated in an overlayered manner has resulted in increase in risk of causing the foam body to fall off from the spayed surface.
(2) There have been probabilities that a cyclic siloxane or the like desorbed from a silicone-based foam stabilizer to be dispersed in the air would cause any electrical-contact failure or the like to adversely affect the malfunction or the like in electrical and electronic equipment and the like. In Canada and Europe, it has been considered that such a cyclic siloxane is a regulated substance having an adverse effect on water quality, and is not environmentally friendly.
(3) Due to being inferior in storage stability of undiluted form, there have been cases where the sediments of raw material are generated during in-place construction to adversely affect productivity of the construction and durability of construction machinery.
(4) For the use of HFO-1233zd as a foaming agent, there have been cases where such a foaming agent stored together with the polyol component for a long period of time after preparation is likely to be decomposed under the influence of an amine-based catalyst or the like so as to generate HF (hydrogen fluoride), which is likely to decompose the silicone-based foam stabilizer or the like, thus resulting in failure to undergo foaming.

### BRIEF SUMMARY

In view of the foregoing, at least one of the objectives of the present disclosure is to provide a urethane resin composition having flame-retardancy as properties suitable for a thermal insulation layer made for a building without being added with any foam stabilizer to avoid problems caused by such addition.

### Means for Solving Problems

One aspect of the present invention made in order to solve the above-described problems is directed to a urethane resin composition for forming a foam body in a thermal insulation material for a building, the foam body having at least quasi-incombustibility in a heat generation test in conformity with ISO-5660 standard, the urethane resin composition comprising: a polyisocyanate compound; an ester-based polyol compound; a trimerization catalyst; an additive; a foaming agent; and a non-silicone-based surface conditioner that is an acrylic surface conditioner, wherein the urethane resin composition is free from any silicone-based foam stabilizer, and wherein the additive comprises a combination of red phosphorus as an indispensable component, and at least one of a phosphate-containing flame retardant and a chlorine-containing flame retardant, wherein the phosphate-containing flame retardant is at least one selected from the group consisting of phosphate, phosphite, hypophosphite, monophosphate, pyrophosphate and polyphosphate.

Further, in the above aspect of the present invention, the phosphate-containing flame retardant may be at least one of ammonium polyphosphate and aluminum phosphite.

Further, in any one of the above aspects of the present invention, the chlorine-containing flame retardant may be a chlorine-based phosphoric acid ester.

Further, in any one of the above aspects of the present invention, the foaming agent comprises an HFO-containing foaming agent containing an hydrofluoroolefin (HFO).

Further, in the above aspect of the present invention, the foaming agent may further comprise water.

Further, in any one of the above aspects of the present invention, the urethane resin composition may further comprise an ether-based polyol compound.

Further, in any one of the above aspects of the present invention, the urethane resin composition may further comprise an adhesion promoter.

Further, in any one of the above aspects of the present invention, the urethane resin composition may further comprise at least one of a urethanization foaming catalyst and a urethanization metal catalyst.

Further, in any one of the above aspects of the present invention, the urethane resin composition may further comprise a dispersant.

Still further, another aspect of the present invention may be directed to a method for thermally-insulating a building comprising the steps of: using the urethane resin composition, described in any one of all the above aspects, as a sprayed-on foam-in-place thermal insulation material.

### Advantageous Effects of the Disclosure

At least one of the below-described advantageous effects could be achieved by the present disclosure:
(1) According to the present disclosure, the adhesion of the foam body is improved as a result of excluding the foam stabilizer from the urethane resin composition. More specifically, the use of a silicone-based foam stabilizer used as raw material of the polyurethane foam incurs a risk of reducing the adhesion, upon repetition of overlayer spraying, due to increase in slipperiness of a skin layer surface. Such a risk of concern is avoidable by disuse of the silicone-based foam stabilizer. According to the present disclosure, therefore, such a foam-stabilizer free urethane resin composition is the most suitable for use in the formation of thermal insulation layers of buildings by spraying in-place in particular.
(2) According to the present disclosure, a cyclic siloxane is not desorbed/dispersed as a result of excluding the silicone-based foam stabilizer, in particular, from the urethane resin composition so that neither malfunction due to electrical-contact failure or the like in electrical and electronic equipment or the like nor water pollution is adversely affected.
(3) According to the present disclosure, as a result of incorporating therein the phosphate-containing flame retardant and/or the chlorine-containing flame retardant in addition to the red phosphorus, a higher level of flame-retardancy due to the action of dehydration condensation, hydrolysis, dehydration carbonization (effect of intumescence) and the formation of a foam layer during combustion.
(4) According to the present disclosure, as a result of excluding the foam stabilizer from the urethane resin composition, there does not occur a problem that: the HFO-containing foaming agent such as HFO1233zd is decomposed under the influence of the amine-based catalyst or the like to generate HF likely to decompose the silicone-based foam stabilizer or the like thus failing to undergo foaming; or the related chemical reaction is delayed in progress. As a result, the HFO-containing foaming agent could be used, without any problems, to obtain the effects by the use of the HFO-containing foaming agent (improvement in long-term storage stability of the raw material, improvement in in-place constructability).

### BRIEF DESCRIPTIONS OF THE SEVERAL VIEWS OF THE DRAWINGS

FIG. 1 shows a comparison table of test results with or without a foam stabilizer.

FIG. 2 shows a comparison table of test results for different sort of a surface conditioner.

FIG. 3 shows a comparison table of test results with or without an ether-based polyol compound.

FIG. 4 shows a comparison table of test results with or without an adhesion promoter.

FIG. 5 shows a comparison table of test results with or without a urethanization catalyst or a metal resinification catalyst.

FIG. 6 shows a comparison table of test results with or without a dispersant.

FIG. 7 shows a comparison table of test results with or without a phosphate-containing flame retardant or a chlorine-containing flame retardant.

### DETAILED DESCRIPTION

[1] Entire Composition Of Components

A urethane resin composition according to an embodiment of the present disclosure is a composition, for forming a foam body in a thermal insulation material for a building, including at least a polyisocyanate compound, an ester-based polyol compound, a trimerization catalyst, an additive and a non-silicone-based surface conditioner, without including any foam stabilizer.

Further, the foam body specified by the above components is characterized by having at least quasi-incombustibility in a heat generation test in conformity with the ISO-5660 standard.

The thermal insulation layer may be formed in the building by: a method in which a polyisocyanate compound (first liquid) and other components (second liquid) obtained in advance by dividing a set of all the above components are so mixed while both being atomized together as to be sprayed; and another method in which the first and second liquids are sprayed while both being mixed together.

[2] In Respect Of Incombustibility

As described above, each of the components of the urethane resin composition according to an embodiment of the present disclosure is determined so that the urethane resin composition has at least quasi-incombustibility in a heat generation test in conformity with the ISO-5660 standard, i.e., the urethane resin composition belongs to the incombustible and quasi-incombustible materials in TABLE 1 below.

TABLE 1

| Property of | | |
|---|---|---|
| Material | Heat Time | Required Performances |
| Incombustible | 20 minutes | (1) Gross calorific value is lower than |
| Quasi- | 10 minutes | or equal to 8 MJ/m². |
| incombustible | | (2) The maximum heat release rate |
| | | does not exceed 200 kW/m² |
| | | continuously over 10 seconds. |
| Flame- | 5 minutes | (3) There is no cracks or holes |
| retardant | | penetrating through the material to the |
| | | rear surface thereof, which is harmful |
| | | from a flame-repellence viewpoint. |

The optimum mixing ratio of each component is required to be provided appropriately by experiment.

Hereinafter, each component will be described in detail.

[3] Polyisocyanate Compound

The polyisocyanate compound is used as a main agent in the urethane resin composition according to an embodiment of the present disclosure.

Such a polyisocyanate compound includes, e.g., an aromatic polyisocyanate, an alicyclic polyisocyanate, an aliphatic polyisocyanate and the like.

The aromatic polyisocyanate includes, e.g., phenylene diisocyanate, tolylene diisocyanate, xylylene diisocyanate, diphenylmethane diisocyanate, dimethyldiphenylmethane diisocyanate, triphenylmethane triisocyanate, naphthalene diisocyanate, polymethylene polyphenyl polyisocyanate and the like.

The alicyclic polyisocyanate includes, e.g., cyclohexylene diisocyanate, methylcyclohexylene diisocyanate, isophorone diisocyanate, dicyclohexylmethane diisocyanate, dimethyldicyclohexylmethane diisocyanate and the like.

The aliphatic polyisocyanate includes, e.g., methylene diisocyanate, ethylene diisocyanate, propylene diisocyanate, tetramethylene diisocyanate, hexamethylene diisocyanate and the like.

One sort of polyisocyanate compound may be used, or two or more sorts thereof may be used.

It is preferred, for ease to use and availability, that diphenylmethane diisocyanate be applied for the main agent of the urethane resin composition.

It is preferred that the content (% by weight) of the isocyanate compound in the urethane resin composition be set within 20 to 80%, while the frame-retardancy deteriorates when the content of the isocyanate compound is less than 20%, and the adhesion of the urethane resin composition to a framework or the like deteriorates when the content of the isocyanate compound is more than 80%.

[4] Polyol Compound

The polyol compound is a material to be used as a curing agent of the urethane resin composition according to an embodiment of the present disclosure.

The polyol compound includes an ester-based polyol compound or an ether-based polyol compound, and a combination thereof.

[4.1] Ester-Based Polyol Compound

The ester-based polyol compound includes, e.g., a polymer obtained by dehydration condensation among a polybasic acid and polyhydric alcohol, a polymer obtained by ring-opening polymerization of lactone such as ε-caprolactone or α-methyl-ε-caprolactone, and a condensate obtained by a hydroxycarboxylic acid and the above-described polyhydric alcohol.

More specifically, for the above polybasic acid, adipic acid, azelaic acid, sebacic acid, terephthalic acid, isophthalic acid, succinic acid and the like are applied. It is preferred that terephthalic acid modification be applied in favor of the flame-retardancy, and fatty acid modification be applied in favor of the adhesion.

It is preferred that the content (% by weight) of the ester-based compound in the urethane resin composition be set within 20 to 80%, while the adhesion of the urethane resin composition to the framework or the like deteriorates when the content of the ester-based compound is less than 20%, and a resin strength of the urethane resin composition decreases, when the content of the ester-based compound is more than 80%, which causes problems such as shrinkage to occur.

[4.2] Other Polyol Compounds

Other polyol compounds include, e.g., polylactone polyol, polycarbonate polyol, aromatic polyol, alicyclic polyol, aliphatic polyol, polymer polyol, polyether polyol and the like.

The polylactone polyol includes, e.g., polypropiolactone glycol, polycaprolactone glycol, polyvalerolactone glycol and the like.

The polycarbonate polyol includes, e.g., polyol or the like obtained by causing a dealcoholization reaction to occur between: a hydroxyl group-containing compound such as ethylene glycol, propylene glycol, butanediol, pentanediol, hexanediol, octanediol, nonanediol; and diethylene carbonate, dipropylene carbonate or the like. The aromatic polyol includes, e.g., bisphenol A, bisphenol F, phenol novolak, cresol novolak and the like.

The alicyclic polyol includes, e.g., cyclohexanediol, methylcyclohexanediol, isophoronediol, dicyclohexylmethanediol, dimethyldicyclohexylmethanediol and the like.

The aliphatic polyol includes, e.g., ethylene glycol, propylene glycol, butanediol, pentanediol, hexanediol and the like.

The polyhydric alcohol includes, more specifically e.g., bisphenol A, ethylene glycol, 1,2-propylene glycol, 1,4-butanediol, diethylene glycol, 1,6-hexane glycol, neopentyl glycol and the like.

The hydroxycarboxylic acid includes, more specifically e.g., castor oil, a reaction product of castor oil and ethylene glycol and the like.

It is preferred that the aromatic polyol be applied in favor of the flame-retardancy.

[5] Trimerization Catalyst

The trimerization catalyst is a material for causing a reaction to occur among isocyanate groups included in the polyisocyanate compounds so as to trimerize the isocyanate groups thereby promoting the formation of an isocyanurate ring.

For such a trimerization catalyst, e.g.: nitrogen-containing aromatic compounds such as tris(dimethylaminomethyl)phenol, 2,4-bi s(dimethylaminomethyl)phenol and 2,4,6-tris(dialkylaminoalkyl)hexahydro-S-triazine;

carboxylic acid alkali metal salts such as potassium acetate, potassium 2-ethylhexanoate and potassium octylate; tertiary ammonium salts such as trimethylammonium salt, triethylammonium salt and triphenylammonium salt; and quaternary ammonium salts such as tetramethylammonium salt, tetraethylammonium salt and tetraphenylammonium salt, may be applied.

It is preferred that a combination of carboxylic acid alkyl metal salts and quaternary ammonium salts be applied in favor of the adhesion and flame-retardancy at low temperature.

It is preferred that the content (% by weight) of the trimerization catalyst by weight of the urethane resin in the urethane resin composition be set within 1 to 20%, while the flame-retardancy of the urethane resin composition deteriorates when the content of the trimerization catalyst by weight of the urethane resin is less than 1%, and the reaction proceeds excessively fast, when the content of the trimerization catalyst by weight of the urethane resin is more than 20%, which causes problems such as clogging of a mixing portion of a spray gun to occur.

[6] Additive

The additive is an element to be used to impart the flame-retardancy to the urethane resin composition according to an embodiment of the present disclosure.

The additive includes red phosphorus as an indispensable component in combination with at least one of a phosphate-containing flame retardant and a chlorine-containing flame retardant.

[6.1] Red Phosphorus

The red phosphorus includes an element for suppressing a gross calorific value during combustion.

No particular limitation is imposed on embodiments of red phosphorus used in an embodiment of the present disclosure, and commercially available products may be appropriately adopted to be used. In consideration of an embodiment in the presence of a produced polyol liquid, however, it is preferred that red phosphorus, classified under the Japanese Fire Services Act as a Class-2 hazardous material, be surface-treated with a thermoplastic or the like so as to be suppressed in susceptibility to the oxidation while being improved in safety and stability, and such a treated one be used.

It is preferred that the content (% by weight) of the red phosphorus by weight of the urethane resin in the urethane resin composition be set within 0.3 to 25%, while the flame-retardancy of the urethane resin composition deteriorates when the content of the red phosphorous by weight of the urethane resin is less than 0.3%, and there may be problems such as clogging of a mixing portion of a spray gun caused to occur when the content of the red phosphorous by weight of the urethane resin is more than 25%.

[6.2] Phosphate-Containing Flame Retardant

The phosphate-containing flame retardant includes an element to be used, in combination with the red phosphorus, for further suppressing the gross calorific value.

The phosphate-containing flame retardant used in this embodiment contains phosphoric acid.

The phosphate-containing flame retardant includes, e.g., phosphates based upon: various sorts of phosphoric acid; and at least one metal or compound selected from the group consisting of metals of Groups IA to IVB of the Periodic Table, ammonia, aliphatic amines and aromatic amines.

The metals of Groups IA to IVB of the Periodic Table include lithium, sodium, calcium, barium, iron(II), iron(III), aluminum and the like.

The aliphatic amine includes methylamine, ethylamine, diethylamine, triethylamine, ethylenediamine, piperazine and the like.

The aromatic amine includes pyridine, triazine, melamine, ammonium and the like.

The above-described phosphate-containing flame retardant may be subjected to a known water-resistance improvement treatment such as a silane-coupling agent treatment, a melamine-resin coating treatment and the like, or may have a known foaming aid agent such as melamine, pentaerythritol and the like added thereto.

More specifically, the phosphate-containing flame retardant includes, e.g., monophosphate, pyrophosphate, polyphosphate and the like.

The monophosphate is not particularly limited to but includes, e.g.: ammonium salts such as ammonium phosphate, ammonium dihydrogen phosphate and diammonium hydrogen phosphate; sodium salts such as monosodium phosphate, disodium phosphate, trisodium phosphate, monosodium phosphite, disodium phosphite and sodium hypophosphite; potassium salts such as monopotassium phosphate, dipotassium phosphate, tripotassium phosphate, monopotassium phosphite, dipotassium phosphite and potassium hypophosphite; lithium salts such as monolithium phosphate, dilithium phosphate, trilithium phosphate, monolithium phosphite, dilithium phosphite and lithium hypophosphite; barium salts such as barium dihydrogen phosphate, barium hydrogen phosphate, barium trisphosphate, barium hypophosphite; magnesium salts such as magnesium monohydrogen phosphate, magnesium hydrogen phosphate, trimagnesium phosphate and magnesium hypophosphite; calcium salts such as calcium dihydrogen phosphate, calcium hydrogen phosphate, tricalcium phosphate and calcium hypophosphite; and zinc salts such as zinc phosphate, zinc phosphite and zinc hypophosphite.

Further, the polyphosphate is not particularly limited to but includes, e.g., ammonium polyphosphate, piperazine polyphosphate, melamine polyphosphate, ammonium polyphosphate, aluminum polyphosphate and the like.

Out of the above compounds, it is preferred that polyphosphates be used in the aspect that self-extinguishing property of the phosphate-containing flame retardant is improved, and it is further preferred that ammonium polyphosphate be used, and aluminum phosphite of which a foam layer is formed during heating be used.

One sort of phosphate-containing flame retardant may be used, or two or more sorts thereof may be used.

It is preferred that the content (% by weight) of the phosphate-containing flame retardant by weight of the urethane resin in the urethane resin composition be set within 0.3 to 25%, while the flame-retardancy of the urethane resin composition deteriorates when the content of the phosphate-containing flame retardant by weight of the urethane resin is less than 0.3%, and there may be problems such as clogging of a mixing portion of a spray gun and powder sedimentation of raw material stirred within a short period of time either caused to occur when the content of the phosphate-containing flame retardant by weight of the urethane resin is more than 25%.

[6.3] Chlorine-Containing Flame Retardant

The chlorine-containing flame retardant includes an element for suppressing the maximum heat release rate at the initial stage of combustion.

Five sorts of flame retardant listed below are widely used as the chlorine-containing flame retardant:
(a) Tris(chloroethyl) phosphate (TCEP) CAS No. 115-96-8
(b) Tris(β-chloropropyl) phosphate (TCPP) CAS No. 13674-84-5
(c) Tris(dichloropropyl) phosphate (TDCP) CAS No. 13674-87-8
(d) Tetrakis(2-chloroethyl)dichloroisopentyl diphosphate (V6) CAS No. 38051-10-4
(e) Polyoxyalkylenebis(dichloroalkyl) phosphate (CR-504L)

CAS No. 184530-92-5

It is preferred that the content (% by weight) of the chlorine-containing flame retardant by weight of the urethane resin in the urethane resin composition be set within 2 to 30%, while the flame-retardancy of the urethane resin composition deteriorates when the content of the chlorine-containing flame retardant by weight of the urethane resin is less than 2%, and a resin strength of the urethane resin composition decreases, when the content of the chlorine-containing flame retardant by weight of the urethane resin is more than 30%, which causes problems such as shrinkage to occur.

[7] Non-Silicone-Based Surface Conditioner

The non-silicone-based surface conditioner includes, e.g., an acrylic surface conditioner.

Such an acrylic surface conditioner includes a solvent-free surface conditioner containing an acrylic polymer as a main component, and has a function of enhancing the surface free energy of a cured resin.

The acrylic surface conditioner is enabled, by incorporating a highly-polar portion into the molecule, to increase in surface free energy of an added coating film, thereby exerting the effects of improving the wettability and adhesion, and imparting the hydrophilicity, with respect to a topcoat.

Further, due to the fact that the acrylic surface conditioner is a solvent-free liquid product, the addition thereof is facilitated, and the application thereof is not only extensive to a solvent-based coating material but also extensive to a solvent-free coating material.

It is to be noted, in an embodiment of the present disclosure, that a non-silicone-based surface conditioner is used as the surface conditioner in order to prevent the deterioration of the adhesion during lamination, and prevent the falling off and peeling off.

It is preferred that the content of the non-silicone-based surface conditioner in the urethane resin composition be set within 0.2 to 10%, while a predetermined foaming ratio could not be achieved when the content of the non-silicone-based surface conditioner is less than 0.2%, and a resin strength of the urethane resin composition decreases, when the content of the non-silicone-based surface conditioner is more than 10%, which causes problems such as shrinkage to occur.

[8] In Respect Of Foam Stabilizer (Reason For Exclusion From Composition)

The foam stabilizer, having a role of adjusting a surface tension when generating a foam body by trapping the foaming agent by the surface tension, has been considered as an indispensable component in the technical field related to an embodiment of the present disclosure due to the fact that a composition free from such a foam stabilizer turns into a lump of a resin instead of forming a foam body.

On the other hand, the use of the foam stabilizer has disadvantages such as a decrease in self-adhesive force of urethane, the generation of a cyclic siloxane, or an adverse effect on the foamability due to a combination with an HFO foaming agent.

In the urethane resin composition according to an embodiment of the present disclosure, therefore, a foam body having no hindrance as the thermal insulation material for the building is formed by selecting appropriately mixed conditions of other materials even if the foam stabilizer is not included.

[9] Others

The materials to be described below may also be included in the urethane resin composition according to an embodiment of the present disclosure.

[9.1] Foaming Agent

The foaming agent is a material to be used to improve the foaming action when a polyisocyanate compound (first liquid) and other components (second liquid) are mixed to form a foam body.

The foaming agent for promoting foaming of the urethane resin includes, e.g.: water; lower-boiling hydrocarbons such as propane, butane, pentane, hexane, heptane, cyclopropane, cyclobutane, cyclopentane, cyclohexane and cycloheptane; chlorinated aliphatic hydrocarbon compounds such as dichloroethane, propyl chloride, isopropyl chloride, butyl chloride, isobutyl chloride, pentyl chloride and isopentyl chloride; fluorine compounds such as CHF₃, CH₂F₂ and CH₃F; hydrochlorofluorocarbon compounds such as trichloromonofluoromethane, trichlorotrifluoroethane, dichloromonofluoroethane, (e.g., HCFC141b (1,1-dichloro-1-fluoroethane), HCFC22 (chlorodifluoromethane) and HCFC142b (1-chloro-1,1-difluoroethane)); hydrofluorocarbons such as HFC-245fa (1,1,1,3,3-pentafluoropropane) and HFC-365mfc (1,1,1,3,3-pentafluorobutane); hydrofluoroolefins such as HFO-1233zd ((E)-1-chloro-3,3,3-trifluoropropane); organic physical foaming agents such as ether compounds e.g., diisopropyl ether or the like, or mixtures of these compounds; and inorganic physical foaming agents such as nitrogen gas, oxygen gas, argon gas and carbon dioxide gas.

In consideration of the environmental-influence viewpoint along with the excellence in thermal insulation performance, it is preferred that hydrofluoroolefin (HFO) be included as the foaming agent.

The content of the foaming agent is not particularly limited to but may be preferably set within a range of: 0.3 parts by weight to 112 parts by weight; more preferably, 0.3 parts by weight to 67 parts by weight; still more preferably, 1.8 parts by weight to 67 parts by weight; and most preferably, 3.7 parts by weight to 37 parts by weight, based upon 100 parts by weight of the polyol. In the foamable polyurethane composition, the content thereof may be set within a range of: 0.1 parts by weight to 30 parts by weight; more preferably, 0.1 parts by weight to 18 parts by weight; still more preferably, 0.5 parts by weight to 18 parts by weight; and most preferably, 1 parts by weight to 10 parts by weight, based upon 100 parts by weight of the urethane resin.

When the range of the content of the foaming agent is the above lower limit value or more, foaming is promoted, thus making it possible to decrease the density of the molded product thus obtained, and when the range of the content of the above upper limit value or less, it is possible to prevent that a foam is not formed because foaming is not performed.

In an embodiment of the present disclosure, one sort of foaming agent may be used, or two or more sorts thereof may be used.

[9.2] Urethanization Foaming Catalyst

The urethanization foaming catalyst is a material for particularly promoting a reaction between an isocyanate compound and water. More specifically, the foaming of the undiluted solution is promoted by gaseous carbon dioxide generated as a result of the reaction occurring between the isocyanate and water.

Such a urethanization foaming catalyst, more specifically, includes an acid block type foaming catalyst obtained as a result of the neutralization, with carboxylic acid, of chain tertiary amines such as bis(2-dimethylaminoethyl)ether and N,N-dimethylalkylamine, or tertiary amine resin compositions.

From the viewpoint of not causing any decomposition of HFC and HFO, it is preferred that the acid block type foaming catalyst be used.

It is preferred that the content (% by weight) of the urethanization foaming catalyst by weight of the urethane resin in the urethane resin composition be set within 0.1 to 10%, while a predetermined foaming ratio could not be achieved when the content of the urethanization foaming catalyst by weight of the urethane resin is less than 0.1%, and the reaction proceeds excessively fast, when the content of the urethanization foaming catalyst by weight of the urethane resin is more than 10%, which causes problems such as clogging of a mixing portion of a spray gun to occur.

[9.3] Urethanization Metal Catalyst

The urethanization metal catalyst is a material for promoting a reaction between an isocyanate compound and a polyol compound.

Such a urethanization metal catalyst includes metal salts having lead, tin, bismuth, copper, zinc, cobalt, nickel and the like, and preferably an organic acid metal salt having lead, tin, bismuth, copper, zinc, cobalt, nickel and the like, so as to have the effects of not causing any decomposition of HFC and an HFO foaming agent that would occur through an amine-based urethanization catalyst.

It is preferred that the content (% by weight) of the urethanization metal catalyst by weight of the urethane resin in the urethane resin composition be set within 0.1 to 10%, while a predetermined foaming ratio could not be achieved when the content of the urethanization metal catalyst by weight of the urethane resin is less than 0.1%, and the reaction proceeds excessively fast, when the content of the urethanization metal catalyst by weight of the urethane resin is more than 10%, which causes problems such as clogging of a mixing portion of a spray gun to occur.

[9.4] Adhesion Promoter

The adhesion promoter is a material for enhancing the adhesion of the urethane resin composition according to an embodiment of the present disclosure.

Such an adhesion promoter includes, e.g., a cyclic ester and the like.

The adhesion promoter promotes the polymerization of a foam surface so as to suppress the surface flyability likely to occur due to high-index and/or high-water content composition, and realize proper foam adhesion even when a spray foam is applied in low-temperature environment.

[9.5] Dispersant

The dispersant is a material for improving the dispersibility of the flame retardant.

Such a dispersant includes, e.g., an alkylammonium salt of an acidic copolymer having a hydroxyl group.

As a result of incorporating the dispersant in the composition, a wet dispersion rate of red phosphorus during dispersion and a phosphate-containing flame retardant filler is improved while the viscosity being caused to decrease, thereby enabling the mixed filler to increase in mixing amount.

With an increase in mixing amount of the filler, the flame-retardancy is improved.

Further, the effect of delaying largely a timing for the mixed filler to sediment on a container bottom after being stirred by a stirring blade or the like could be achieved.

It is preferred that the content (% by weight) of the dispersant by weight of the urethane resin in the urethane resin composition be set within 0.1 to 10%, while the dispersibility of the filler is not improved when the content of the dispersant by weight of the urethane resin is less than 0.1%, and a resin strength of the urethane resin composition decreases, when the content of the dispersant by weight of the urethane resin is more than 10%, which causes problems such as shrinkage to occur.

### EXAMPLES

Hereinafter, the present disclosure will be described in detail with reference to EXAMPLES. It is to be noted that the present disclosure is in no way limited to EXAMPLES described below.

[1] Test Conditions

With respect to EXAMPLES of foam bodies made through the use of the urethane resin composition according to their respective embodiments of the present disclosure, and REFERENCES (COMPARATIVE EXAMPLES) made by prior art, a variety of tests were performed.

Details of each component used in EXAMPLES and REFERENCES are as follows:
It is to be noted that the numerical value for each component is indicated by parts by weight.

(1) Polyol Compound

A-1: Terephthalic acid polyester polyol (manufactured by Kawasaki Kasei Chemicals Ltd., trade name: MAXIMOL RFK-505, hydroxyl value=250 mgKOH/g)

A-2: Terephthalic acid polyester polyol (manufactured by Kawasaki Kasei Chemicals Ltd., trade name: MAXIMOL RFK-509, hydroxyl value=200 mgKOH/g)

A-3: Aliphatic modified terephthalic acid-based polyol (manufactured by Kawasaki Kasei Chemicals Ltd., trade name: MAXIMOL RLK-087, hydroxyl value=200 mgKOH/g)

A-4: Mannich-based polyol (manufactured by Asahi Glass Co., Ltd., trade name: EXCENOL NB-615, hydroxyl value=579 mgKOH/g)

(2) Trimerization Catalyst

B-1: Potassium octylate (manufactured by Evonik, trade name: DABCO K-15)

B-2: Quaternary ammonium salt (manufactured by Evonik, trade name: TMR-7)

(3) Urethane Foaming Catalyst

C: Tertiary amine salt (manufactured by Evonik, trade name: POLYCAT 201)

(4) Metal Resinification Catalyst

D: Bismuth octylate (manufactured by Shepherd Chemical Company, trade name: Bicat 8210)

(5) Foaming Agent

E-1: Water

E-2: HFO-1233zd (manufactured by Honeywell, trade name: Solstice LBA)

E-3: HFO-1336mzz (manufactured by Chemours Company, trade name: OPTEON1100)

(6) Silicone Foam Stabilizer

F: Silicone (manufactured by Dow Corning Toray Co., Ltd., trade name: SH-193)

(7) Additive

G-1: Red phosphorus (manufactured by RIN KAGAKU KOGYO Co., Ltd., trade name: Nova Excel 140)

G-2: Ammonium polyphosphate (manufactured by TAIHEI CHEMICAL INDUSTRIAL CO., LTD., trade name: Taien CII)

G-3: Aluminum phosphite (manufactured by TAIHEI CHEMICAL INDUSTRIAL CO., LTD., trade name: APA100)

G-4: Chlorine-based phosphoric acid ester tris(β-chloropropyl) phosphate (manufactured by DAIHACHI CHEMICAL INDUSTRY CO., LTD., trade name: TMCPP)

(8) Adhesion Promoter

H: Cyclic ester (manufactured by Momentive, trade name: AP)

(9) Dispersant

I: Wet dispersant, alkylammonium salt of acidic copolymer (manufactured by BYK-Chemi JAPAN KK, trade name: BYK-W969)

(10) Surface Conditioner

J-1: Acrylic polymer (manufactured by Kusumoto Chemicals, Ltd., trade name: SEI-W01)

J-2: Acrylic polymer (manufactured by Kusumoto Chemicals, Ltd., trade name: SEI-1501)

J-3: Anionic polymer (manufactured by Kusumoto Chemicals, Ltd., trade name: AQ-360)

J-4: Vinyl-based polymer (manufactured by Kusumoto Chemicals, Ltd., trade name: UVX-190)

(11) Polyisocyanate

K: Polymeric MDI (manufactured by TOSOH CORPORATION, trade name: Millionate MR-200)

[2] Method for Evaluation of Adhesion

The adhesion was evaluated with “O (circle)” indicative of OK as suitable and “X (cross)” indicative of NG as unsuitable, based upon the adhesive strength of 80 kPa or more in conformity with a method for measuring the adhesive strength of the JIS A9526 standard.

[3] Method For Evaluation Of Flame-Retardancy

Regarding the evaluation of incombustibility, a sample for a cone calorimeter test was prepared for each of the foam bodies of their respective EXAMPLES, and a gross calorific value, the maximum heat release rate, the quasi-incombustibility and the incombustibility were evaluated in a heat generation test in conformity with the ISO-5660 standard.

[4] Outline Of Test

The outline of the heat generation test is as follows:
A sample for a cone calorimeter test is prepared by cutting the foam body into a piece whose dimensions are 10 cm long by 10 cm wide by 5 cm thick.
[Hand] A mixture of a polyol liquid and an isocyanate liquid mixed in advance according to the formulation table was weighed in a 1-liter disposable cup, and after the liquid temperature reaches 15° C., the raw material liquid mixed for 3 to 8 seconds by a 2,800-rpm stirring drill equipped with a cage mixer, was injected into a 200×200×height-free box to fabricate specimens.

The injection was performed twice or more in order to confirm the adhesion during lamination.
[Spray]A mixture of a polyol liquid and an isocyanate liquid mixed in advance according to the formulation table was prepared in a 200-liter drum, and specimens were fabricated under the conditions below.
   Spray equipment: Model A-25, manufactured by GRACO Inc.
   Spray gun: GRACO AP AR4242, manufactured by GRACO Inc.
   Raw material temperature: 60° C.
   Specimen fabrication method: in conformity with the JIS A9526 standard

Through the use of samples for a corn calorimeter test, a gross calorific value and the maximum heat release rate were measured by such a corn calorimeter test when heated at the intensity of radiant heat, 50 kW/m², for 20 minutes in conformity with the ISO-5660 standardized test method, and then a residual state was confirmed.

[5] Test Results

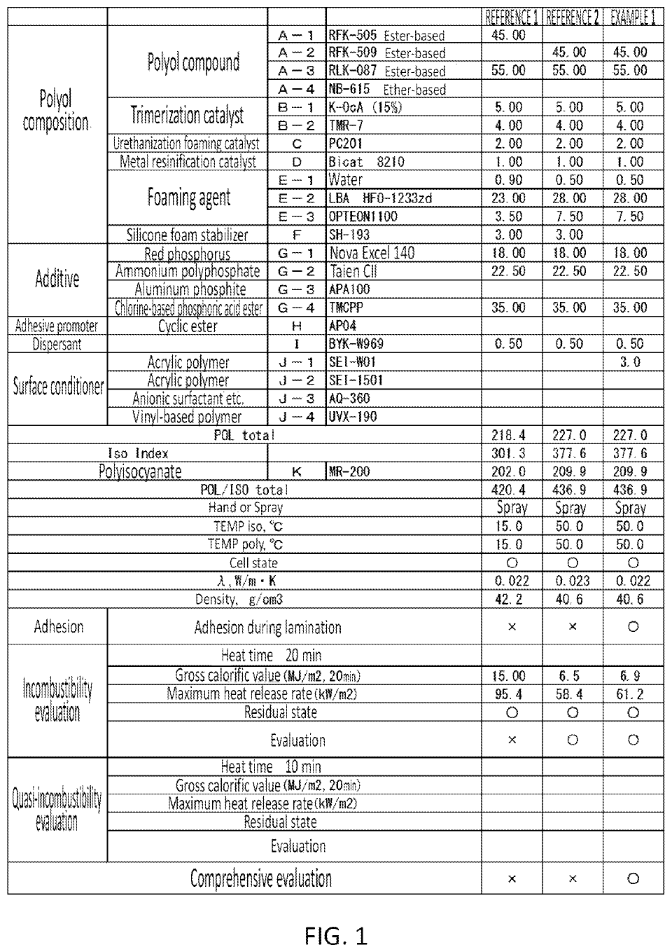

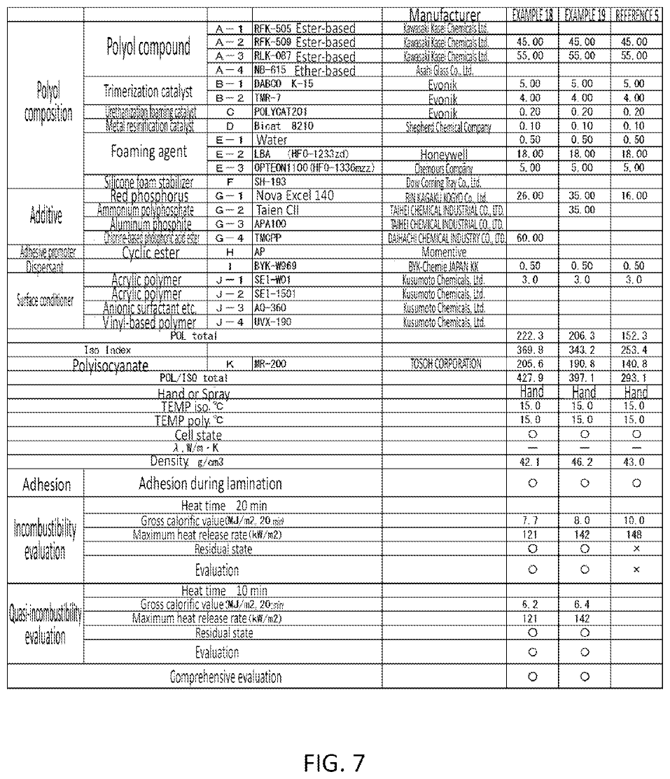

The test results for their respective EXAMPLES and REFERENCES are shown in TABLES 2, 3, and comparison tables in which the test results are extracted for each of the following items are shown in FIGS. 1 to 7.

TABLE 2

| | | | | Manufacturer | REF 1 | REF 2 | EX 1 | EX 2 | EX 3 | REF 3 | REF 4 | EX 4 | EX 5 | EX 6 | EX 7 |
|---|---|---|---|---|---|---|---|---|---|---|---|---|---|---|---|
| Polyol | Polyol | A-1 | [symbol] | [symbol] | 45.00 | | | | 45.00 | 45.00 | 45.00 | | | | |
| composition | compound | A-2 | [symbol] | [symbol] | | 45.00 | 45.00 | 45.00 | | | | 45.00 | 45.00 | 45.00 | 45.00 |
| | | A-3 | [symbol] | [symbol] | [symbol] | [symbol] | [symbol] | [symbol] | [symbol] | [symbol] | [symbol] | [symbol] | [symbol] | [symbol] | [symbol] |
| | | A-4 | [symbol] | [symbol] | | | | | | | | | | | |
| | [symbol] | B-1 | [symbol] | [symbol] | 5.00 | 5.00 | 5.00 | 5.00 | 5.00 | 5.00 | 5.00 | 5.00 | 5.00 | 5.00 | 5.00 |
| | | B-2 | [symbol] | [symbol] | 4.00 | 4.00 | 4.00 | 4.00 | 4.00 | 4.00 | 4.00 | 4.00 | 4.00 | 4.00 | 4.00 |
| | [symbol] | C | [symbol] | [symbol] | 2.00 | 2.00 | 2.00 | 2.00 | 2.00 | 0.20 | 0.20 | 2.00 | 2.00 | 2.00 | 2.00 |
| | [symbol] | D | [symbol] | [symbol] | 1.00 | 1.00 | 1.00 | 1.00 | 1.00 | 1.00 | 1.00 | 1.00 | 1.00 | 1.00 | 1.00 |
| | Foaming agent | E-1 | Water | [symbol] | [symbol] | [symbol] | [symbol] | [symbol] | [symbol] | [symbol] | [symbol] | [symbol] | [symbol] | [symbol] | [symbol] |
| | | E-2 | [symbol] | [symbol] | [symbol] | [symbol] | [symbol] | [symbol] | [symbol] | [symbol] | [symbol] | [symbol] | [symbol] | [symbol] | [symbol] |
| | | E-3 | [symbol] | [symbol] | [symbol] | [symbol] | [symbol] | [symbol] | [symbol] | [symbol] | [symbol] | [symbol] | [symbol] | [symbol] | [symbol] |
| | | F | [symbol] | [symbol] | [symbol] | [symbol] | | | | | | | | | |
| [symbol] | Red phosphorus | G-1 | [symbol] | [symbol] | [symbol] | [symbol] | [symbol] | [symbol] | [symbol] | [symbol] | [symbol] | [symbol] | [symbol] | [symbol] | [symbol] |
| | [symbol] | G-2 | [symbol] | [symbol] | [symbol] | [symbol] | [symbol] | | | | | [symbol] | [symbol] | [symbol] | [symbol] |
| | [symbol] | G-3 | [symbol] | [symbol] | | | | [symbol] | [symbol] | [symbol] | [symbol] | | | | |
| | [symbol] | G-4 | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | H | | [symbol] | | | | | | | | | | | |
| [symbol] | | I | | [symbol] | | | [symbol] | [symbol] | [symbol] | [symbol] | [symbol] | [symbol] | [symbol] | [symbol] | [symbol] |
| [symbol] | acrylic polmer | J-1 | | [symbol] | | | [symbol] | 1.00 | | | | | | | |
| | acrylic polmer | J-2 | | [symbol] | | | | | 1.00 | | | | | | |
| | [symbol] | J-3 | | [symbol] | | | | | | 1.00 | | | | | |
| | [symbol] | J-4 | | [symbol] | | | | | | | [symbol] | | | | |

| [symbol] | | | | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|
| [symbol] | | | | [symbol] | [symbol] | [symbol] | [symbol] | [symbol] | [symbol] | [symbol] | [symbol] | [symbol] | [symbol] | [symbol] |
| Polysocyanate | K | [symbol] | [symbol] | [symbol] | [symbol] | [symbol] | [symbol] | [symbol] | [symbol] | [symbol] | [symbol] | [symbol] | [symbol] | [symbol] |

| [symbol] | | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|
| Hand or Spray | | Spray | Spray | Spray | Spray | Hand | Hand | Hand | Spray | Hand | Hand | Hand |
| Temp Iso ° C. | | [symbol] | [symbol] | [symbol] | [symbol] | [symbol] | [symbol] | [symbol] | [symbol] | [symbol] | [symbol] | [symbol] |
| Temp poly ° C. | | [symbol] | [symbol] | [symbol] | [symbol] | [symbol] | [symbol] | [symbol] | [symbol] | [symbol] | [symbol] | [symbol] |
| Cell State | | [symbol] | [symbol] | [symbol] | [symbol] | [symbol] | [symbol] | [symbol] | [symbol] | [symbol] | [symbol] | [symbol] |
| [symbol] | | [symbol] | [symbol] | [symbol] | [symbol] | [symbol] | [symbol] | [symbol] | [symbol] | [symbol] | [symbol] | [symbol] |
| [symbol] | | [symbol] | [symbol] | [symbol] | [symbol] | [symbol] | Resin | Resin | [symbol] | [symbol] | [symbol] | [symbol] |
| Adhesion | Adhesion during lamination | [symbol] | [symbol] | [symbol] | [symbol] | [symbol] | | | [symbol] | [symbol] | [symbol] | [symbol] |
| [symbol] | Heat time 20 min | [symbol] | [symbol] | [symbol] | [symbol] | [symbol] | | | [symbol] | [symbol] | [symbol] | [symbol] |
| [symbol] | [symbol] | [symbol] | [symbol] | [symbol] | [symbol] | [symbol] | | | [symbol] | [symbol] | [symbol] | [symbol] |
| | [symbol] | [symbol] | [symbol] | [symbol] | [symbol] | [symbol] | | | [symbol] | [symbol] | [symbol] | [symbol] |
| | [symbol] | [symbol] | [symbol] | [symbol] | [symbol] | [symbol] | | | [symbol] | [symbol] | [symbol] | [symbol] |
| | Evaloution | | | | | | | | | | | |
| [symbol] | [symbol] | | | | | | | | [symbol] | [symbol] | [symbol] | [symbol] |
| | [symbol] | | | | | | | | [symbol] | [symbol] | [symbol] | [symbol] |
| | [symbol] | | | | | | | | [symbol] | [symbol] | [symbol] | [symbol] |
| | Evaloution | | | | | | | | [symbol] | [symbol] | [symbol] | [symbol] |

| | | | | | | | | | | | |
|---|---|---|---|---|---|---|---|---|---|---|---|
| Comprehensive evaluation | [symbol] | [symbol] | [symbol] | [symbol] | [symbol] | [symbol] | [symbol] | [symbol] | [symbol] | [symbol] | [symbol] |

[symbol]

indicates data missing or illegible when filed

TABLE 3

| | | | | Manufacturer | EX 8 | EX 9 | EX 10 | EX 11 | EX 12 | EX 13 | EX 14 | EX 15 | EX 16 | EX 17 | EX 18 | EX 19 | REF 5 |
|---|---|---|---|---|---|---|---|---|---|---|---|---|---|---|---|---|---|
| Polyol | Polyol | A-1 | [symbol] | [symbol] | | 45.00 | | | 45.00 | 45.00 | 45.00 | 45.00 | 45.00 | 45.00 | | | |
| compo- | compound | A-2 | [symbol] | [symbol] | 45.00 | | 45.00 | 45.00 | | | | | | | 45.00 | 45.00 | 45.00 |
| sition | | A-3 | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | | A-4 | [symbol] | [symbol] | | | | 5.00 | | | | | | | | | |
| | [symbol] | B-1 | [symbol] | [symbol] | 5.00 | 5.00 | 5.00 | 5.00 | 5.00 | 5.00 | 8.00 | 6.00 | .00 | 5.00 | 5.00 | 5.00 | 6.00 |
| | | B-2 | [symbol] | [symbol] | 4.00 | 4.00 | 4.00 | 4.00 | 4.00 | 4.00 | 4.00 | 4.00 | 4.00 | 4.00 | 4.00 | 4.00 | 4.00 |
| | [symbol] | C | [symbol] | [symbol] | 2.00 | 2.00 | 2.00 | 2.00 | 2.00 | 0.20 | 0.20 | 2.00 | 2.00 | 2.00 | 2.00 | [symbol] | [symbol] |
| | [symbol] | D | [symbol] | [symbol] | 1.00 | 1.00 | 1.00 | 1.00 | 1.00 | 1.00 | 1.00 | 1.00 | 1.00 | 1.00 | 1.00 | [symbol] | [symbol] |
| | Foaming agent | E-1 | Water | [symbol] | [symbol] | [symbol] | [symbol] | [symbol] | [symbol] | [symbol] | [symbol] | [symbol] | [symbol] | [symbol] | [symbol] | [symbol] | [symbol] |
| | | E-2 | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | | E-3 | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | | F | [symbol] | [symbol] | [symbol] | [symbol] | | | | | | | | | | | |
| [symbol] | Red phosphorus | G-1 | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | G-2 | [symbol] | [symbol] | [symbol] | [symbol] | [symbol] | | | | | [symbol] | [symbol] | [symbol] | [symbol] | | |
| | [symbol] | G-3 | [symbol] | [symbol] | | | | [symbol] | [symbol] | [symbol] | [symbol] | | | | | | |
| | [symbol] | G-4 | [symbol] | [symbol] | [symbol] | [symbol] | [symbol] | [symbol] | [symbol] | [symbol] | [symbol] | [symbol] | [symbol] | [symbol] | [symbol] | | |
| [symbol] | [symbol] | H | | [symbol] | | | | | | | | | | | | | |
| [symbol] | | I | | [symbol] | | | [symbol] | [symbol] | [symbol] | [symbol] | [symbol] | [symbol] | [symbol] | [symbol] | [symbol] | [symbol] | [symbol] |
| [symbol] | acrylic polymer | J-1 | | [symbol] | | | [symbol] | 1.00 | | | | | | | | | |
| | acrylic polymer | J-2 | | [symbol] | | | | | 1.00 | | | | | | | | |
| | [symbol] | J-3 | | [symbol] | | | | | | 1.00 | | | | | | | |
| | [symbol] | J-4 | | [symbol] | | | | | | | [symbol] | | | | | | |

| [symbol] | | | | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|---|---|
| [symbol] | | | | [symbol] | [symbol] | [symbol] | [symbol] | [symbol] | [symbol] | [symbol] | [symbol] | [symbol] | [symbol] | [symbol] | [symbol] | [symbol] |
| Polysocyanate | K | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

| [symbol] | | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|
| Hand or Spray | | Hand | Hand | Hand | Hand | Hand | Spray | Hand | Hand | Hand | Hand | Hand | Hand | Hand |
| Temp Iso ° C. | | [symbol] | [symbol] | [symbol] | [symbol] | [symbol] | [symbol] | [symbol] | [symbol] | [symbol] | [symbol] | [symbol] | [symbol] | [symbol] |
| Temp polly ° C. | | [symbol] | [symbol] | [symbol] | [symbol] | [symbol] | [symbol] | [symbol] | [symbol] | [symbol] | [symbol] | [symbol] | [symbol] | [symbol] |
| Cell State | | [symbol] | [symbol] | [symbol] | [symbol] | [symbol] | [symbol] | [symbol] | [symbol] | [symbol] | [symbol] | [symbol] | [symbol] | [symbol] |
| [symbol] | | [symbol] | [symbol] | [symbol] | [symbol] | [symbol] | [symbol] | [symbol] | [symbol] | [symbol] | [symbol] | [symbol] | [symbol] | [symbol] |
| [symbol] | | [symbol] | [symbol] | [symbol] | [symbol] | [symbol] | [symbol] | [symbol] | [symbol] | [symbol] | [symbol] | [symbol] | [symbol] | [symbol] |
| Adhesion | Adhesion during | [symbol] | [symbol] | [symbol] | [symbol] | [symbol] | [symbol] | [symbol] | [symbol] | [symbol] | [symbol] | [symbol] | [symbol] | [symbol] |
| | lamination | | | | | | | | | | | | | |
| [symbol] | Heat time 20 min | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | Evaluation | | | | | | | | | | | | | |
| [symbol] | [symbol] | [symbol] | [symbol] | [symbol] | [symbol] | [symbol] | [symbol] | [symbol] | [symbol] | [symbol] | [symbol] | [symbol] | [symbol] | |
| | [symbol] | [symbol] | [symbol] | [symbol] | [symbol] | [symbol] | [symbol] | [symbol] | [symbol] | [symbol] | [symbol] | [symbol] | [symbol] | |
| | [symbol] | [symbol] | [symbol] | [symbol] | [symbol] | [symbol] | [symbol] | [symbol] | [symbol] | [symbol] | [symbol] | [symbol] | [symbol] | |
| | Evaluation | [symbol] | [symbol] | [symbol] | [symbol] | [symbol] | [symbol] | [symbol] | [symbol] | [symbol] | [symbol] | [symbol] | [symbol] | |

| | | | | | | | | | | | | |
|---|---|---|---|---|---|---|---|---|---|---|---|---|
| Comprehensive evaluation | [symbol] | [symbol] | [symbol] | [symbol] | [symbol] | [symbol] | [symbol] | [symbol] | [symbol] | [symbol] | [symbol] | [symbol] d |

[symbol]

indicates data missing or illegible when filed

[5.1] With or without Foam Stabilizer (REFERENCES 1, 2 and EXAMPLE 1)

FIG. 1 shows a comparison of the test results with or without the foam stabilizer.

When the urethane resin composition containing the foam stabilizer (silicone-based foam stabilizer) shown in REFERENCES 1, 2, the adhesion was unsuitable.

In EXAMPLE 1 having the foam stabilizer removed (excluded) from the composition shown in REFERENCE 2 and having a surface conditioner newly added, there was no problem in adhesion.

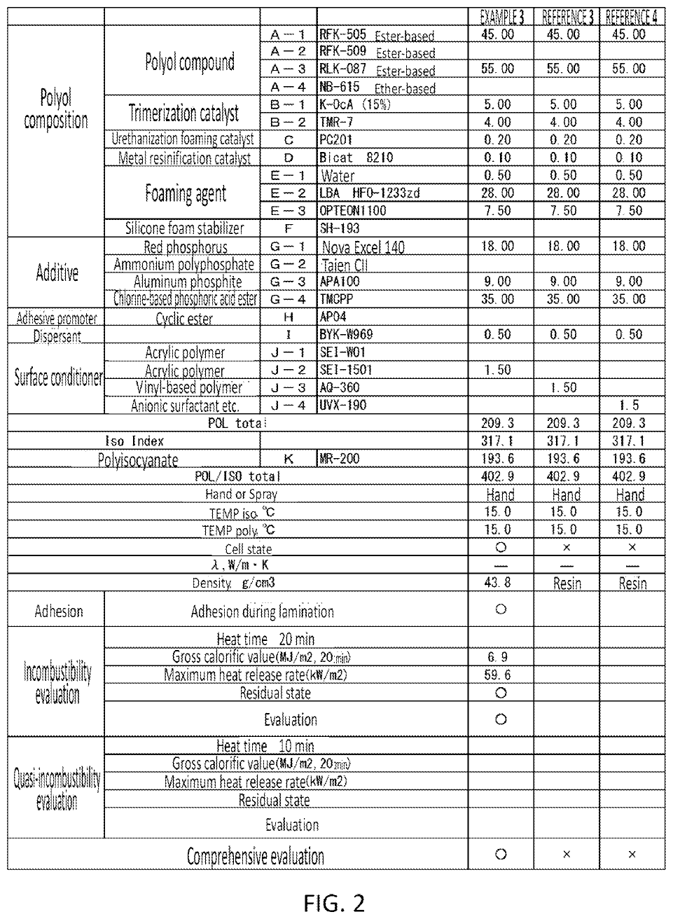

In an embodiment of the present disclosure, therefore, it is presumed that not including the foam stabilizer (foam-stabilizer free) is an important factor for ensuring the adhesion.

[5.2] Differences in Sort of Surface Conditioner (EXAMPLE 3 and REFERENCES 3, 4) FIG. 2 shows a comparison of the test results due to a difference in sort of a surface material.

In EXAMPLE 3, a surface conditioner of a non-silicone-based acrylic polymer was used, and there was no problem in evaluation of the adhesion and incombustibility.

On the other hand, when a surface conditioner such as an anionic surfactant or a surface conditioner of a vinyl-based polymer was used as in REFERENCES 3, 4, the cell state of the foam was unpreferable.

For incorporating the surface conditioner in an embodiment of the present disclosure, therefore, it is presumed that a non-silicone-based acrylic polymer surface conditioner is preferable.

[5.3] With or without Ether-Based Polyol Compound (EXAMPLES 10, 11)

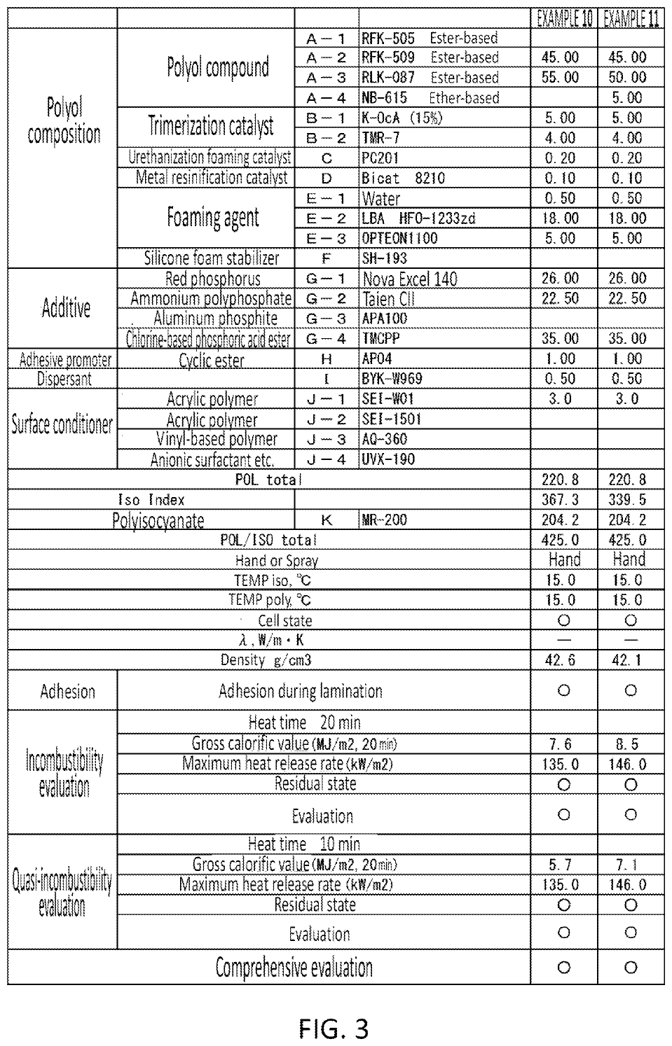

FIG. 3 shows a comparison of the test results with or without the ether-based polyol compound.

When EXAMPLE 10 in which an ester-based polyol compound is selected as the polyol compound and EXAMPLE 11 in which an ether-based polyol compound is further added to EXAMPLE 10 are compared, there was no problem in the evaluation of adhesion, incombustibility and quasi-incombustibility in all of the EXAMPLES, and there was no large difference between both.

In an embodiment of the present disclosure, therefore, it is presumed that there is no problem in using the ester-based polyol compound and the ether-based polyol compound in combination as the polyol compound.

[5.4] With or without Adhesion Promoter (EXAMPLES 8, 10)

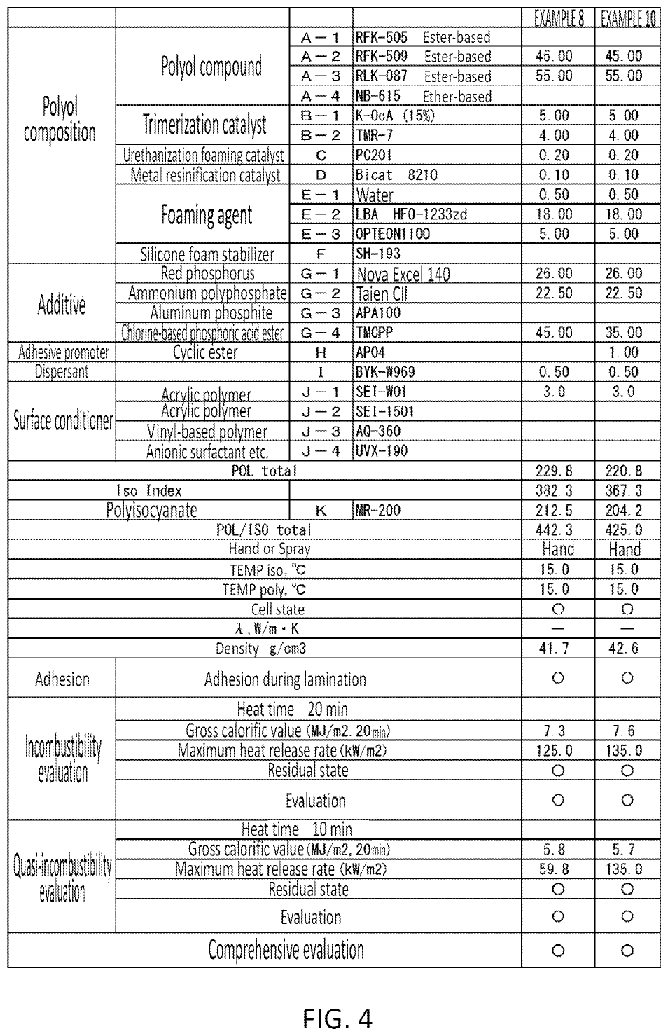

FIG. 4 shows a comparison of the test results with and without the adhesion promoter.

Although the composition was different between EXAMPLE 8 and EXAMPLE 10 only in the presence or absence of the adhesion promoter, there was no problem in the evaluation of adhesion, incombustibility and quasi-incombustibility in all of the EXAMPLES.

In an embodiment of the present disclosure, therefore, it is presumed that there is no problem in newly adding the adhesion accelerator.

[5.5] With or without Urethanization Catalyst or Metal Resinification Catalyst (Examples 14 to 16)

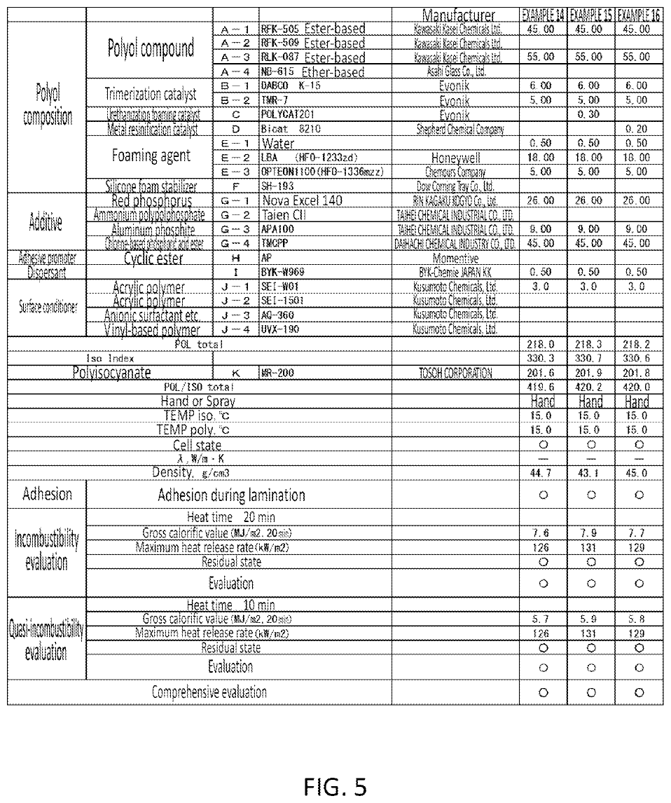

FIG. 5 shows a comparison of the test results with and without a urethanization catalyst or a metal resinification catalyst.

Among EXAMPLES 14 to 16, the composition differed only in the presence or absence of the urethanization catalyst and the metal resinification catalyst, and there was no problem in the evaluation of adhesion, incombustibility and quasi-incombustibility in all of the EXAMPLES.

In an embodiment of the present disclosure, therefore, it is presumed that there is no problem in newly adding the urethanization catalyst or the metal resinification catalyst.

[5.6] With or without Dispersant (EXAMPLES 12, 17)

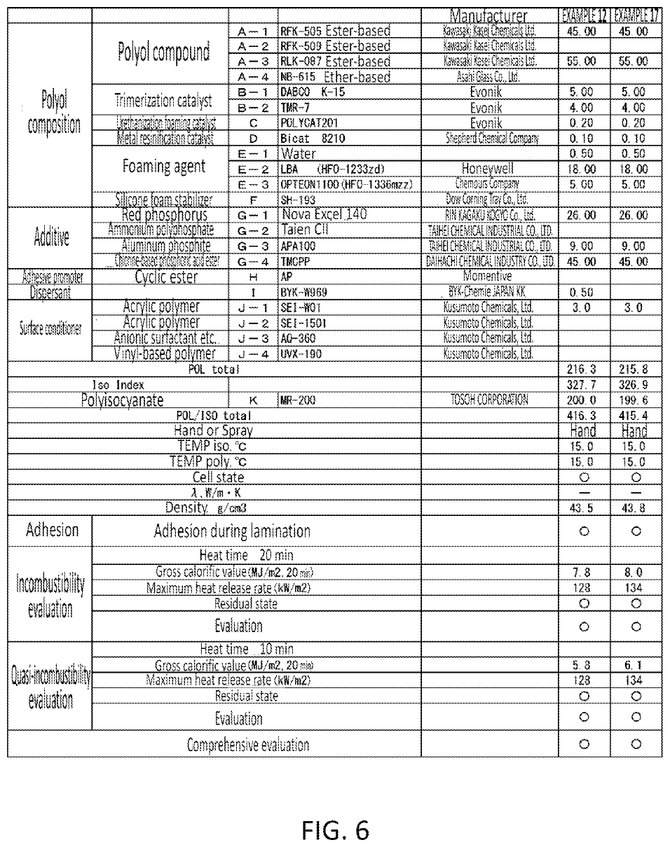

FIG. 6 shows a comparison of the test results with and without the dispersant.

Although the composition was different between EXAMPLE 12 and EXAMPLE 17 only in the presence or absence of the dispersant, there was no problem in the evaluation of adhesion, incombustibility and quasi-incombustibility in all of the EXAMPLES.

In the present disclosure, therefore, it is presumed that there is no problem in newly adding the urethanization catalyst or the metal resinification catalyst.

[5.7] With or without Phosphate-Containing Flame Retardant or Chlorine-Containing Flame Retardant (EXAMPLES 18, 19 and REFERENCE 5)

FIG. 6 shows a comparison of the test results with and without the dispersant.

Although the composition was different between EXAMPLE 12 and EXAMPLE 17 only in the presence or absence of the dispersant, there was no problem in the evaluation of adhesion, incombustibility and quasi-incombustibility in all of the EXAMPLES.

In the present invention, therefore, it is presumed that there is no problem in newly adding the dispersant.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A urethane resin composition for forming a foam body in a thermal insulation material for a building, the foam body having at least quasi-incombustibility in a heat generation test in conformity with ISO-5660 standard, the urethane resin composition comprising:
a polyisocyanate compound;
an ester-based polyol compound;
a trimerization catalyst;
an additive;
a foaming agent; and
a non-silicone-based surface conditioner that is an acrylic surface conditioner,
wherein the urethane resin composition is free from any silicone-based foam stabilizer, and
wherein the additive comprises a combination of:
red phosphorus as an indispensable component, and
at least one of a phosphate-containing flame retardant and a chlorine-containing flame retardant, wherein the phosphate-containing flame retardant is at least one selected from the group consisting of phosphate, phosphite, hypophosphite, monophosphate, pyrophosphate and polyphosphate.

2. The urethane resin composition according to claim 1, wherein the phosphate-containing flame retardant is at least one of ammonium polyphosphate and aluminum phosphite.

3. The urethane resin composition according to claim 1, wherein the chlorine-containing flame retardant is a chlorine-based phosphoric acid ester.

4. (canceled)

5. The urethane resin composition according to claim 1, wherein the foaming agent comprises an HFO-containing foaming agent containing an hydrofluoroolefin (HFO).

6. The urethane resin composition according to claim 1 further comprising an ether-based polyol compound.

7. The urethane resin composition according to claim 1 further comprising an adhesion promoter.

8. The urethane resin composition according to claim 1 further comprising at least one of a urethanization foaming catalyst and a urethanization metal catalyst.

9. The urethane resin composition according to claim 1 further comprising a dispersant.

10. A method for thermally-insulating a building comprising the steps of: using the urethane resin composition, according to claim 1, as a sprayed-on foam-in-place thermal insulation material.

11. The urethane resin composition according to claim 5, wherein the foaming agent further comprises water.
